(19) United States
(12) Patent Application Publication
(10) Pub. No.: US 2005/0122322 A1
(43) Pub. Date: Jun. 9, 2005

(54) Document creating method apparatus and program for visually handicapped person

(76) Inventors: Hirotaka Furuya, Ishikawa (JP); Hiroshi Kakutani, Ishikawa (JP)

Correspondence Address: STAAS & HALSEY LLP, SUITE 700, 1201 NEW YORK AVENUE, N.W., WASHINGTON, DC, 20005, US

(21) Appl. No.: 10/487,271

(22) PCT Filed: Apr. 21, 2003
(86) PCT No.: PCT/JP03/05034

(30) Foreign Application Priority Data
May 2, 2002 (JP) 2002-130394

(51) Int. Cl. G06T 1/00

(52) U.S. Cl. 345/418

(57) ABSTRACT

According to the invention, a document is created through steps of inputting handwritten characters by the use of a mouse or a pen-tablet, recognizing the inputted characters, and determining to use the characters. A transparent virtual window is created on a screen of a display device. In the transparent virtual window, continuity is established between upper and lower boundaries and between left and right boundaries of an input region so as to remove upper, lower, left, and right frame boundaries which would otherwise limit the input region. A handwritten character is inputted and displayed on the thus-created transparent window. Accordingly, a visually handicapped person can input characters on a personal computer in a simple manner.

### TECHNICAL FIELD

The present invention relates to a document creating method, apparatus, and program for a visually handicapped person, which create a document through operation of inputting handwritten characters by means of a mouse, a pen-tablet, or the like; recognizing the inputted characters; and determining to use the characters.

### BACKGROUND ART

Conventional methods for inputting characters to editor software mainly include a method of inputting characters on a keyboard and a method of inputting characters on a character input pad. When a visually handicapped person inputs a character on a keyboard, the person encounters difficulty in recognizing the positions of keys.

FIG. 8 shows the status in which a [Japanese hiragana] character “a” has been inputted in a predetermined input region on an input pad. Generally, in inputting a character on the input pad, an input region is limited, and such a character must be inputted within the limited region. However, a visually handicapped person cannot recognize the input region and determine a starting position and extent of inputting.

Japanese Patent Application Laid-Open (kokai) No. Hei 9-91082 discloses a character recognition technique that enables correct recognition of an intended character without providing a frame in which a handwritten character is to be inputted. However, this technique remains similar to the above-described conventional technique in that the character input region is limited.

Further, because a visually handicapped person cannot recognize key position and menu position when operating editor software, he or her cannot perform a process such as “correction of an erroneously input character,” “file saving,” or “printing.”

### DISCLOSURE OF INVENTION

As described above, the method of inputting a character on a keyboard, an input pad, or the like has hitherto known. However, such a conventional method has the problem that a visually handicapped person cannot recognize a key position, a character input region, or the like, and thus encounters a severe hardship in inputting a character.

Accordingly, an object of the present invention is to cope with such problems and to provide an environment under which a visually handicapped person can input characters on a personal computer in a simple manner. Namely, the present invention enables a visually handicapped person to input a handwritten character without being conscious of the starting position of inputting and the extent of inputting and to input to editor software the result of recognition of the input handwritten character.

Another object of the present invention is to enable a handicapped person to correct a character erroneously input, through character recognition, and to perform a process such as “file saving” or “printing.”

A document creating method, apparatus, and program for a visually handicapped person according to the present invention create a document through procedures of inputting handwritten characters (one at a time) by means of a mouse, a pen-tablet, or the like; recognizing the input characters; and determining to use the characters. In the method, apparatus, and program of the present invention, a transparent virtual window is created on a screen of a display device, and in the transparent virtual window, continuity is established between upper and lower boundaries and between left and right boundaries of an input region so as to remove upper, lower, left, and right frame boundaries which would otherwise limit the input region. A handwritten character is input and displayed on the thus-created transparent window.

### BRIEF DESCRIPTION OF THE DRAWINGS

FIG. 1 is a concept view of the present invention, illustrating a procedure of inputting a handwritten character, recognizing the inputted character, and supplying the result of the recognition to document creating software.

FIG. 2 is a block diagram showing an exemplary data process, from the recognition of a handwritten character to the outputting of the recognized character to editor software.

FIG. 3 is a view illustrating the continuity of an input region.

FIG. 4 is a view illustrating the manner in which a handwritten character is displayed.

FIG. 5 is a flow chart showing an exemplary data processing procedure.

FIG. 6 is a view illustrating a character inputting operation procedure.

FIG. 7 is a view illustrating an erroneous character correcting procedure.

FIG. 8 is a view illustrating the manner in which a character is inputted according to the conventional technique.

### BEST MODE FOR CARRYING OUT THE INVENTION

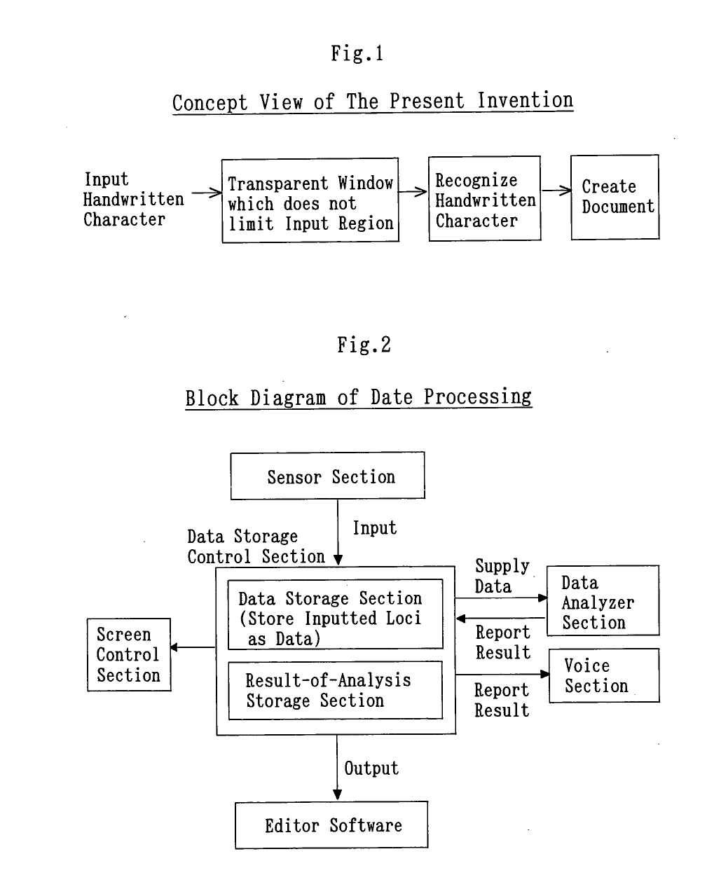

The present invention will be described below by way of example. FIG. 1 is a concept view of the present invention, illustrating a procedure of inputting a handwritten character, recognizing the inputted character, and supplying the result of the recognition to document creating software.

A transparent window which does not impose a restriction on an input region is created on the screen of a display device, and in the created window, a handwritten character is inputted by means of a mouse or a pen-tablet. Recognition of the inputted handwritten character is performed by use of known recognition software. Voice feedback of the result of input of a handwritten character and the contents of a process enables a user to change the inputted character when, for example, the character differs from one that the user has attempted to input. In order to correct such an erroneously input character, the user selects a proper character from candidate characters by means of inputting a handwritten character, to thereby correct the erroneously input character.

Then, the handwritten character to be used is determined and is transferred to document creating software (such as a memo pad). Processes of confirming and saving the created document or the like can be performed through a simple operation of inputting corresponding handwritten characters. The role of a keyboard (functions of various keys such as a space key, a backspace key, and a delete key) can be performed by inputting corresponding handwritten characters.

FIG. 2 is a block diagram showing an exemplary data process, from recognition of a handwritten character to outputting of the recognized character to editor software. A handwritten locus is inputted to a data storage control section from a sensor section such as a mouse or a pen-tablet. The inputted locus is stored into a data storage section as data. The stored data is used to display the inputted locus on the screen through a screen control section and, in the meantime, the stored data are supplied to a data analyzer section. The data analyzer section analyzes the stored data, reports the result of the analysis to the data storage control section, and stores the result of the analysis into a result-of-analysis storage section. The stored result of analysis is reported to the user in the form of voice through a voice section, and is outputted to editor software.

Next, the handwritten-character recognition operation will be described in greater detail. First, handwritten character recognition software (hereinafter called “the present software”) constructed under the application of the present invention is started. By registering the present software for start-up, the present software can be started when a computer is booted. Alternatively, the present software may be started by selecting the present software or the icon of the present software on a desktop. The present software provides a virtual system control window in which upper, lower, left, and right frame boundaries are removed in order to establish continuity of the input region, to thereby allow a visually handicapped person to input a character without being conscious of the input start position and the input region. Further, the software can control other software to be used (editor software and mail software).

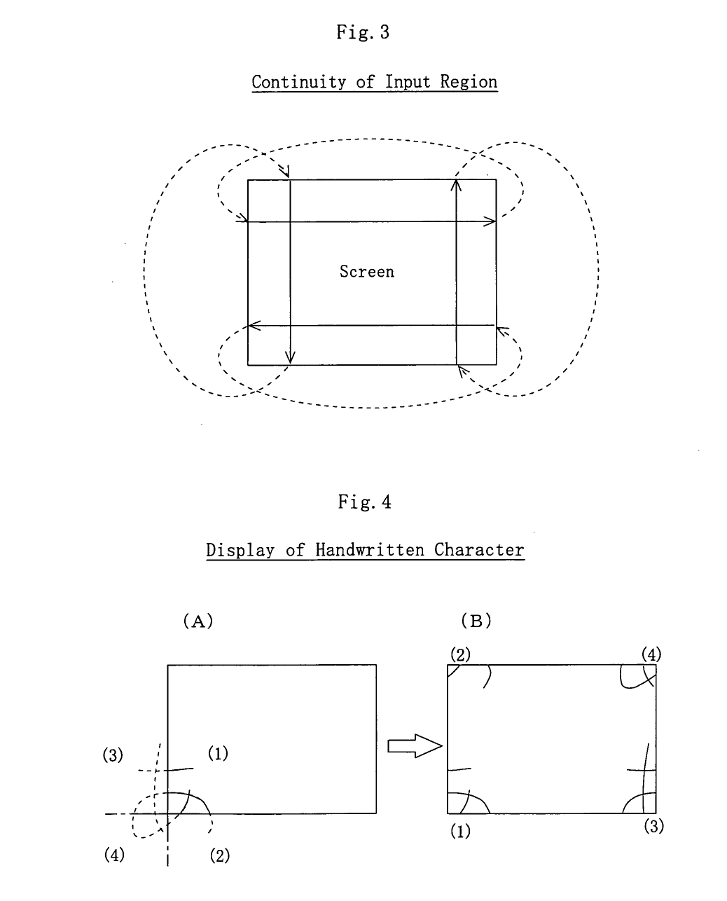

In the present description, the “continuity of the input region” means a state created through an operation as exemplified in FIG. 3. When the lowermost portion of the screen of the display device is reached, continuation from the lowermost portion to the uppermost portion of the screen is established. When the rightmost portion of the screen is reached, continuation from the rightmost portion to the leftmost portion of the screen is established. Inversely, when the uppermost portion of the screen of the display device is reached, continuation from the uppermost portion to the lower portion of the screen is established; and when the leftmost portion of the screen is reached, continuation from the leftmost portion to the rightmost portion of the screen is established. This “boundary-less input region” can be realized through obtaining the current position (coordinate) of a mouse by use of a mouse event from the system. The system is configured in such a manner that, when the mouse moves to a certain coordinate (the upper, lower, left, or right end of the screen), the position of the mouse pointer is moved to the opposite coordinate (slightly inside the upper, lower, left, or right end on the screen). This configuration enables the input region to be recognized as boundary-less or continuous.

Assume that a [Japanese hiragana] character “a” has been inputted in a lower left position on the screen as shown in FIG. 4(A). According to the conventional technique, a portion of this [Japanese hiragana] character “a,” which portion is located within the screen; i.e., only the upper right portion (1), is displayed, and the remaining portions (2), (3) and (4), which are indicated by dotted lines, are neither recognized nor displayed at all. In contrast, according to the present invention, as shown in FIG. 4(B), the lower right portion (2), the upper left portion (3), and the lower left portion (4) of the [Japanese hiragana] character “a” are displayed at the upper left portion, the lower right portion, and the upper right portion, respectively, of the screen, and the entirety of the character (its locus) is detected and recognized as being continuous.

In other words, the inputted character is displayed within the screen without projecting off the screen, irrespective of the position of the mouse pointer. Further, an inputted character portion is displayed in superposition with another image already displayed on the screen, so as not to conceal the already displayed image. Therefore, the window can be said to be “a transparent virtual window which does not limit the input region.” This transparent virtual window may be set to a predetermined size within the physical screen size of the display device, but the size of the transparent virtual window should preferably match the entire screen so that the screen can be used effectively. When a visually handicapped person is accompanied by a non-handicapped person serving as an attendant, some sort of display must also be provided for the non-handicapped person. In such a situation, it is sufficiently effective for the non-handicapped person to recognize the inputted character from the individual character portions displayed in a divided condition, as shown in FIG. 4(B).

The present software controls, or supplies character data to, another piece of software as follows. When a certain command (e.g., “ [symbol] ”K to be described later) is inputted, the preset software reports a keyboard event or message to a target software, to thereby control the target software and/or supply characters thereto.

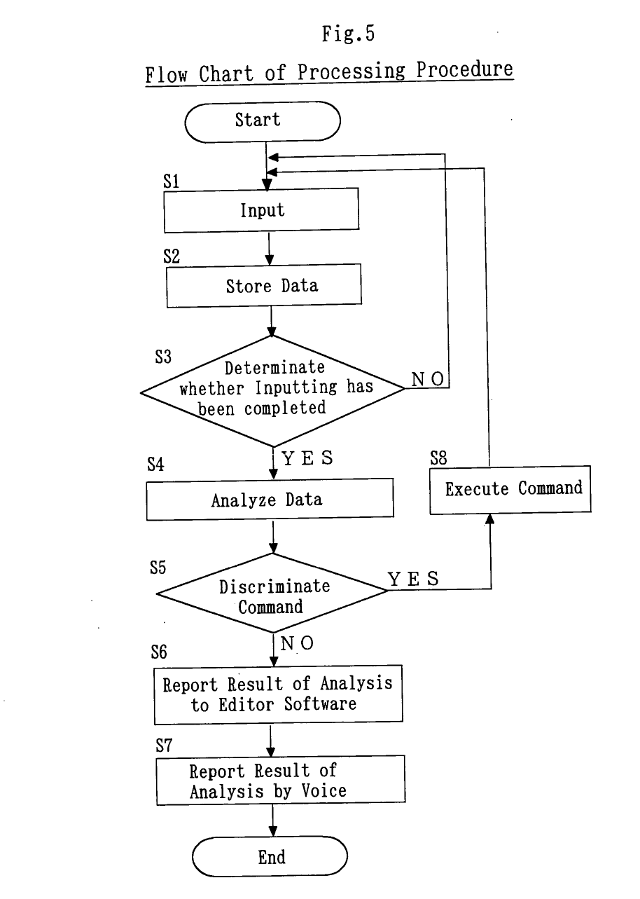

FIG. 5 is a flow chart showing an exemplary data processing procedure. Loci inputted (S1) by means of a mouse or a pen-tablet are stored (S2) as data. Determination as to whether or not the inputting has been completed (S3) is performed. When the inputting has not yet been completed, the procedure returns to step S1. When the inputting has been completed, the inputted locus data are analyzed (S4). The inputting of a single character is determined to have been completed when a predetermined time (which may be freely set) elapses after stoppage of data input. Alternatively, the inputting of a single character may be determined to have been completed upon detection of right-clicking a mouse (pushing down a button on a pen in the case of a pen-tablet).

Next, there is performed a command discrimination operation for determining whether or not the input character or symbol is a command (S5). When the input character or symbol is a command, a process corresponding to the command is executed (S8), whereupon the procedure returns to step S1. When the input character or symbol is not a command, the result of analysis is reported to editor software (S6). Further, the result of analysis is reported by voice (S7), ending this procedure.

The specific operation procedure will now be described in greater detail.

1. Character Inputting Operation Procedure:

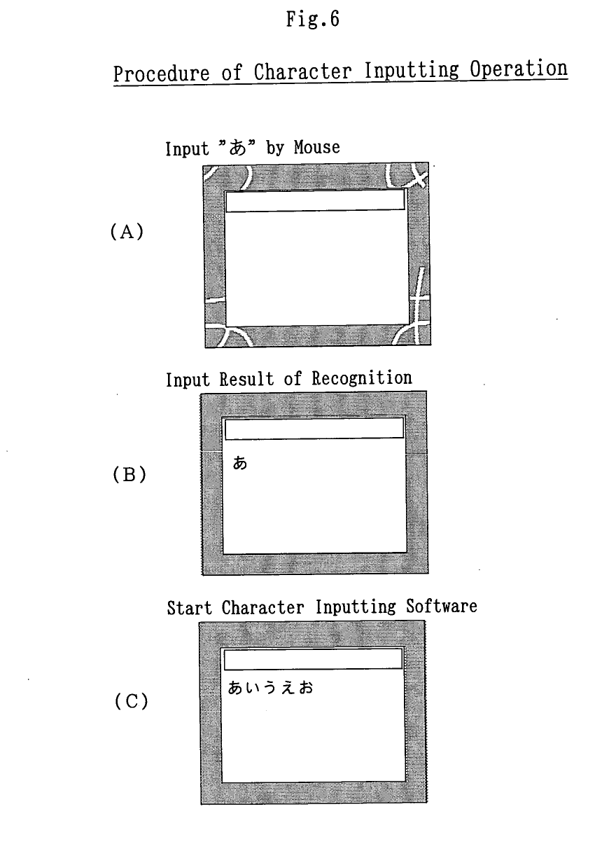

FIG. 6 is a view explaining a character inputting operation procedure. Character inputting software (such as a memo pad) and the present software are started, and a character such as “a” [Japanese hiragana] is inputted by means of a mouse as shown in FIG. 6(A). As described with reference to FIG. 4, [Japanese hiragana] character “a” is displayed in a divided condition at four corners of the screen.

Recognition is performed upon completion of input of a single character. The result of recognition is shown in FIG. 6(B). This result of recognition is supplied to character inputting software (such as a memo pad). At the same time, the inputted character is fed back to the user by voice.

As the foregoing operation is repeatedly executed, a document as shown in FIG. 6(C) is created. Thus, creation of a document is completed.

2. Erroneous Character Correcting Procedure:

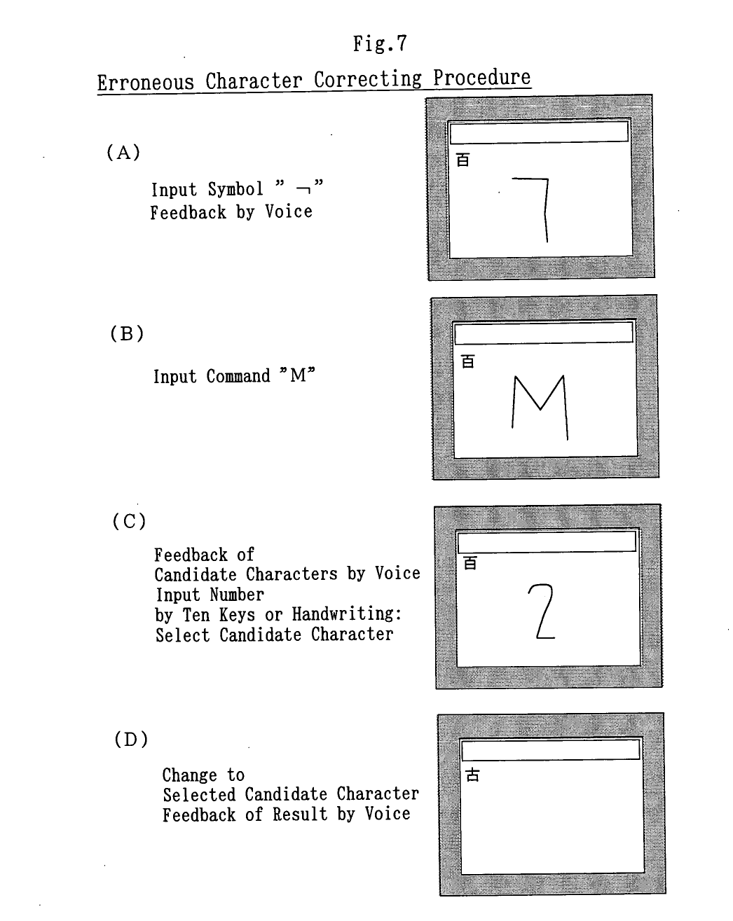

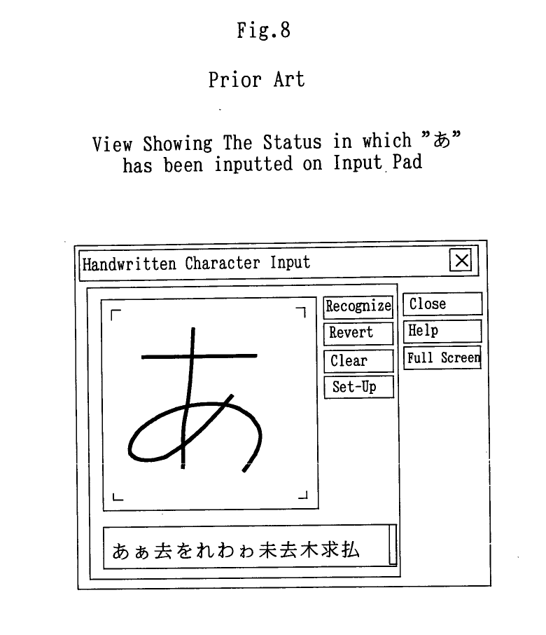

FIG. 7 is a view illustrating an erroneous character correcting procedure. FIG. 7(A) shows a state in which a character “hyaku” [Japanese kanji meaning hundred] is displayed as the result of recognition. When a user wishes to change the displayed character to another character, the user first inputs a symbol “ [symbol] .” In response to this input, the system enters a command input status, which is reported to the user by means of voice feedback.

Next, as shown in FIG. 7(B), the user inputs a command; e.g., “M”. In response thereto, candidate characters are provided to the user by means of voice feedback (e.g., “first candidate: Japanese kanji numerical character ‘hyaku’” [meaning hundred] and “second candidate: Japanese kanji character ‘ko’ [meaning old]”).

Then, the user selects a candidate character by inputting a number by means of ten keys or handwriting as shown in FIG. 7(C).

As shown in FIG. 7(D), the character “hyaku” is changed to the selected candidate character ‘ko.’ Simultaneously, this result is fed back by voice. Thus, correction of the erroneously input character is completed.

3. Kana-Kanji Conversion Procedure:

When the user inputs the symbol “ [symbol] ,” the system enters a command inputting status, which is reported to the user by means of voice feedback.

Then, the user inputs a command “S.” In response thereto, the system notifies the user by voice that a kana-kanji conversion command has been enabled.

Then, the user inputs a character such as “a” [Japanese hiragana] by means of a mouse or the like. The thus-input character is recognized, and is supplied to character inputting software (such as a memo pad). At the same time, the inputted character is fed back to the user by voice. The foregoing operation is repeatedly executed.

Then, when the user inputs a command “E,” the system loudly reads candidates for kana-kanji conversion (for example, when Japanese kana characters “ai” are to be converted into a Japanese kanji character, the system loudly reads the first candidate “ai” [Japanese kanji character meaning love], the second candidate “ai” [Japanese kanji character meaning phase], etc.).

The user selects a candidate kanji character by inputting a corresponding number by means of ten keys or handwriting. As a result, the inputted character is deleted, and the selected character is input. At the same time, the inputted character is reported by voice. Thus, the kana-kanji conversion is completed.

4. Procedures for Spacing, New Line, Confirmation of Character, Deletion of Character:

When the user inputs the symbol “ [symbol] ,” the system enters a command inputting status, which is reported to the user by means of voice feedback.

Then, the user inputs a character corresponding to a desired one of various processes as a command. For example, the user inputs “K” for input of a space, “R” for starting a new line, “H” for character confirmation, or “B” for character deletion.

In response thereto, a process corresponding to the input command is performed, and, at the same time, the result of the process is reported by voice. Thus, the process is completed.

### INDUSTRIAL APPLICABILITY

According to the present invention, a document can be created through a procedure of inputting handwritten characters by means of a mouse or a pen-tablet; recognizing the inputted characters; and determining to use the characters. Accordingly, a visually handicapped person can enjoy the following advantageous results.

A visually handicapped person:

can create a document in a simple manner.
can create a document or the like by him- or herself without depending on any attendant, and therefore can write a private note or the like without bothering other persons.
does not have to be concerned about the starting position of inputting, because the input region is not limited.
does not have to be concerned about the size of a character, because the input region is not limited (a character never projects off the screen).
can grasp the current operation status by means of voice feedback.

1. A document creating method for a visually handicapped person adapted to create a document through procedures of inputting a handwritten character by use of a sensor, such as a mouse or a pen-tablet, recognizing the input character, and determining to use the character, the method comprising:
creating, on a screen of a display device, a transparent virtual window in which continuity is established between upper and lower boundaries and between left and right boundaries of an input region so as to remove upper, lower, left, and right frame boundaries which would otherwise limit the input region; and
allowing a user to input a handwritten character on the created transparent virtual window and displaying the input character on the created transparent virtual window.

2. A document creating method for a visually handicapped person according to claim 1, wherein the result of inputting of the handwritten character and contents of processing are fed back to the user by voice.

3. A document creating method for a visually handicapped person according to claim 1, wherein, when an erroneous character or the like has been inputted, a proper character is selected from candidate characters by inputting a handwritten character, to thereby change or correct the inputted character.

4. A document creating method for a visually handicapped person according to claim 1, wherein a process such as confirming or saving the created document or the like is performed by inputting a handwritten character.

5. A document creating method for a visually handicapped person according to claim 1, wherein the function of each key of a keyboard is performed by inputting a handwritten character.

6. A document creating apparatus for a visually handicapped person adapted to create a document through procedures of inputting a handwritten character by use of a sensor, such as a mouse or a pen-tablet, recognizing the input character, and determining to use the character, the apparatus comprising:
means for creating, on a screen of a display device, a transparent virtual window in which continuity is established between upper and lower boundaries and between left and right boundaries of an input region so as to remove upper, lower, left, and right frame boundaries which would otherwise limit the input region; and
means for allowing a user to input a handwritten character on the created transparent virtual window and displaying the input character on the created transparent virtual window.

7. A document creating program for a visually handicapped person adapted to create a document through procedures of inputting a handwritten character by use of a sensor, such as a mouse or a pen-tablet, recognizing the input character, and determining to use the character, the program causing a computer to perform:
a step of creating, on a screen of a display device, a transparent virtual window in which continuity is established between upper and lower boundaries and between left and right boundaries of an input region so as to remove upper, lower, left, and right frame boundaries which would otherwise limit the input region; and
a step of allowing a user to input a handwritten character on the created transparent virtual window and displaying the input character on the created transparent virtual window.
